(19) United States
(12) Patent Application Publication
(10) Pub. No.: US 2015/0160448 A1
(43) Pub. Date: Jun. 11, 2015

(54) STEREO MICROSCOPE SYSTEM

(71) Applicant: KOH YOUNG TECHNOLOGY INC., Seoul (KR)

(72) Inventors: Jong-Kyu Hong, Gwangju-si (KR); Hyun-Ki Lee, Daegu (KR); Min-Young Kim, Daegu (KR); Jae-Heon Chung, Gwangyeong-si (KR)

(73) Assignee: KOH YOUNG TECHNOLOGY INC., Seoul (KR)

(21) Appl. No.: 14/241,953

(22) PCT Filed: Apr. 19, 2013
(86) PCT No.: PCT/KR2013/003354

§ 371 Date: Feb. 28, 2014

(30) Foreign Application Priority Data
Apr. 27, 2012 (KR) 10-2012-0044786

(51) Int. Cl. G02B 21/36; H04N 13/04

(52) U.S. Cl. CPC G02B 21/361; G02B 21/368; G02B 21/367; H04N 13/0402

(57) ABSTRACT

A stereo microscope system capable of display virtual reality through a plurality of sub display parts, which is the same as that embodied through a microscope, and capable of embodying virtual reality with same quality image throughout the plurality of display parts, is provided. According to the stereo microscope, the image capturing part captures the beam passing through the beam splitter part of the prism to capture an image and delivers the image to the processor, and the processor digital processes the image captured by the pair of image capturing part and delivers the image to the first and second display parts and to display the image. Therefore, the image captured by the image capturing part is digital processed by the processor, and the image that is digital processed by the processor is delivered to each of the display part to display so that regular image is displayed regardless of change of amount of light.

### TECHNICAL FIELD

The present invention relates to a stereo microscope system, and more particularly to a stereo microscope system capable of observing an object through stereoscopic image.

### BACKGROUND ART

In general, a microscope includes two lens groups in series, that is, an objective lens group and an ocular lens group for observing a minute structure that cannot be observed through a naked eye.

A stereo microscope including two ocular lens parts for observing an object through stereoscopic image for two eyes has been developed and come into wide use. In stereo microscope, there are two types of Abbe type in which optical axis of objective lens group is parallel to observe an object, and Greenough type in which optical axis of objective lens group forms an specific mechanical angle to object an object.

The stereo type microscope has been also developed for a surgical operation, which can be used for various surgical operations. According to recently developed the stereo microscope for a surgical operation, an object can be observed not only through a direct ocular lens but also through a virtual reality.

However, according to a conventional stereo type microscope, the virtual reality can be displayed only through the ocular lens. Therefore, an assistant or a third party except an operating surgeon cannot observe an object through the virtual reality. Further, according to the conventional stereo type microscope, an incident light is divided into two portions and only a portion is used for the virtual reality so that light amount for the virtual reality is insufficient and a virtual reality image is irregular.

### DETAILED DESCRIPTION OF THE INVENTION

### Objects of the Invention

Therefore, the object of the present invention is to provide a stereo microscope system capable of display virtual reality through a plurality of sub display parts, which is the same as that embodied through a microscope.

Another object of the present invention is to provide a stereo microscope system capable of embodying virtual reality with same quality image throughout the plurality of display parts.

### Technical Solution

A stereo microscope system according to an exemplary embodiment of the present invention includes, a pair of zoom units disposed between objective lens and a pair of ocular lenses; a focusing lens disposed between the pair of zoom unit and the objective lens; a pair of prisms disposed between the pair of zoom units and the pair of ocular lenses, the prisms having a reflecting part reflecting a main beam passing through the zoom units, and a beam splitter part reflecting a portion of the main beam reflected by the reflecting part toward the ocular lenses and transmitting other portion of the main beam, which is not reflected toward the ocular lenses; a pair of image capturing part capturing beam passing through the beam splitter part to capture an image and delivering the image to a processor; and a first display part connected to the processor to display an image that is captured by the pair of image capturing part and digital processed by the processor.

The first display part includes a pair of first displays disposed between the pair of ocular lenses and the pair of prisms to be connected to the processor, the first displays displaying the image that is digital processed by the processor.

The first displays may be a liquid crystal display (LCD).

On the other hand, the first display part includes a second display connected to the processor to display an image that is digital processed by the processor in order to observe the image not through the pair of ocular lenses.

The second display may be a glassless 3D TV.

The stereo microscope system further includes an assistant viewer connected to the processor.

The assistant viewer may include a pair of second displays connected to the processor to display an image that is digital processed by the processor, and a pair of assistant ocular lenses through which an assistant observes the image displayed by the pair of second display parts.

The second display part may be a liquid crystal display (LCD).

### Advantageous Effects

According to the stereo microscope of an embodiment of the present invention, the image capturing part captures the beam passing through the beam splitter part of the prism to capture an image and delivers the image to the processor, and the processor digital processes the image captured by the pair of image capturing part and delivers the image to the first and second display parts and to display the image.

Therefore, the stereo microscope according to the present invention, the image captured by the image capturing part is digital processed by the processor, and the image that is digital processed by the processor is delivered to each of the display part to embody virtual reality so that virtual reality with regular image regardless of change of amount of light.

### BRIEF DESCRIPTION OF THE DRAWINGS

FIG. 1 is a conceptual view illustrating a stereo microscope system according to an exemplary embodiment of the present invention.

### EMBODIMENTS OF THE INVENTION

This invention may be embodied in many different forms, and will be described with reference to the accompanying drawings. But this invention should not be construed as limited to the embodiments set forth herein, but should be understood to include every modifications, equivalents and substitutes

The terms such as ‘first’, ‘second’, etc. may be used for various elements but the elements should not limited by the terms. The terms may be used only for discriminating one element from others. For example, a first element may be named as a second element, and the second element may be named as the first element within the present invention.

The terms used in the present application are only to explain the specific embodiment and is not intended to limit the present invention. The terms “a”, “an” and “the” mean “one or more” unless expressly specified otherwise. The terms “including”, “comprising”, etc., are to designate features, numbers, processes, structural elements, parts, and combined component of the application, and should be understood that it does not exclude one or more different features, numbers, processes, structural elements, parts, combined component.

The technical term or the scientific term that will be used in the specification has the same meaning as a person skilled in the art commonly understood unless defined differently.

The terms defined in a commonly used dictionary should be understood as the context, and should not be understood ideally or excessively unless defined differently.

Hereinafter, preferred embodiments of the present invention will be explained referring to figures.

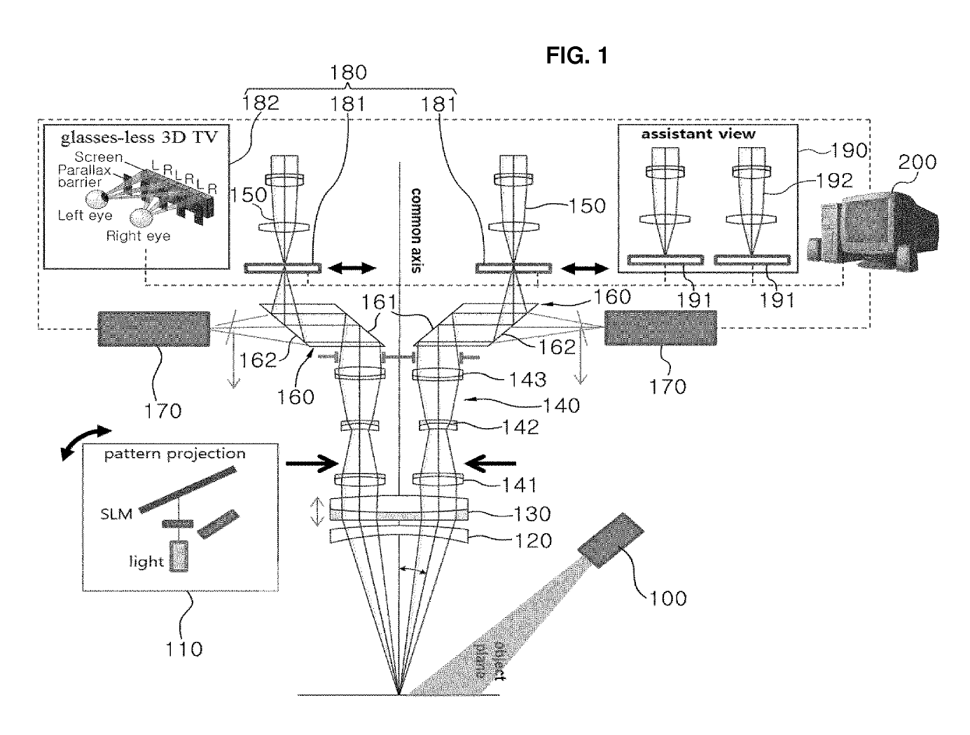

FIG. 1 is a conceptual view illustrating a stereo microscope system according to an exemplary embodiment of the present invention.

Referring to FIG. 1, a stereo microscope system according to an exemplary embodiment of the present invention includes a main beam source 100, a pattern projector 110, an objective lens 120, a focusing lens 130, a pair of zoom units 140, a pair of ocular lenses 150, a pair of prims 160, a pair of image capturing parts 170, a display part 180.

The main beam source 100 emits main beam toward an object.

The pattern projector 110 emits pattern beam toward the object to form a three dimensional image.

The objective lens 120 transmits a main beam emitted by the main beam source 100 and the pattern projector 110 toward an object and reflected by the object.

The focusing lens 130 is disposed over the objective lens 120 and transmits the main beam passing through the objective lens 120, and focuses the main beam by adjusting the distance between the focusing lens 130 and the objective lens 120.

The pair of zoom units 140 is disposed over the focusing lens 130 to adjust magnification. For example, the zoom units 140 include a plurality of zoom lenses 141, 142 and 143. The zoom lenses 141, 142 and 143 are arranged in a line such that the zoom lenses 141, 142 and 143 can move. The pair of zoom units 140 adjusts magnification by adjusting distances among the zoom lenses 141, 142 and 143 neighboring each other. The pair of zoom units 140 can adjust stereo distance by adjusting a spacing distance between the zoom units 140.

The pair of ocular lenses 150 is disposed over the zoom units 140, and an observer observes an image with eyes at the ocular lenses 150.

The pair of prisms 160 is disposed between the pair of zoom units 140 and the pair of ocular lenses 150. The each of prisms 160 includes a reflecting part 161 and a beam splitter part 162. The reflecting part 161 is disposed at a side of the prism 160 to reflect all portions of the main beam passing through the zoom unit 140. The prism 160 reflects a portion of the main beam reflected by the reflecting part 161 toward the pair of ocular lenses 150, and transmits other portion of the main beam, which is not reflected toward the ocular lenses 150.

The pair of image capturing part 170 captures an image by receiving beam passing through the beam splitter part 162 to deliver the image to a processor 200. For example, the pair of image capturing part 170 may embodied through a camera.

The display part 180 is connected to the processor 200 to display an image captured by the image capturing part 170 and digital processed by the processor 200 to embody virtual reality.

The display part 180 includes a pair of first displays 181 and a second display 182.

The pair of first displays 181 is disposed between the pair of ocular lenses 150 and the pair of prisms 160 to be connected to the processor 200, and displays an image that is digital processed by the processor 200 to embody virtual reality. For example, the first display 181 may be embodied through an LCD. The pair of first displays 181 may be movable in a left-right direction to be disposed between the ocular lens 150 and the pair of prism 160 when required, or to be disposed outside of the ocular lens 150 and the pair of prism 160 when not required.

For observing not through the ocular lens 150, the second display 182 is connected to the processor 200 to display an image that is digital processed by the processor 200 to embody virtual reality. For example, the second display 182 may be embodied through glassless 3D TV.

On the other hand, the stereo microscope system according to an exemplary embodiment of the present invention may further include an assistant viewer 190 connected to the processor 200.

The assistant viewer 190 includes a pair of second display parts 191 and a pair of assistant ocular lenses 192. For example, the second display parts 191 are connected to the processor 200 to display an image that is digital processed by the processor 200 to embody virtual reality. The pair of assistant ocular lenses 192 is disposed over the pair of second display parts 191, respectively so that an assistant can observe an image through the assistant ocular lenses 192, which is displayed through the second display parts 191.

Referring again to FIG. 1, an operation and effects of the stereo microscope system according to an exemplary embodiment of the present invention will be explained.

Referring to FIG. 1, when the main beam source 100 or the pattern projector 110 emits main beam or pattern beam toward an objective, the main beam or the pattern beam emitted by the main beam source 100 or the pattern projector 110 reflected by the object and passes through the objective lens 120.

The beam passing through the objective lens 120 is focused when the beam passes through the focusing lens 130.

The beam focused by the focusing lens 130 enters the pair of zoom units 140, and the zoom units 140 adjust magnification of the beam by adjusting distances among the zoom lenses 141, 142 and 143.

The beam of which magnification is adjusted by the zoom units 140 enters the pair of prims 160. The beam entering the prisms 160 is reflected by ninety degrees by the reflecting part 161 of the prism 160 with forty five degrees angle toward the beam splitting part 162. A portion of the beam which arrives at the beam splitter part 162 through the reflecting part 161 is reflected by ninety degrees by the beam splitter part 162 toward the pair of ocular lenses 150, and other portion of the beam which is not reflected by the beam splitter part 162 passes through the beam splitter part 162 toward the pair of image capturing parts 170.

The pair of image capturing parts 170 receives the beam passing through the beam splitter part 162 to capture an image, and delivers the image to the processor 200 connected to the pair of image capturing parts 170.

The image delivered to the processor 200 is digital processed by the processor 200.

The image that is digital processed by the processor 200 is delivered to the first and second display parts 180 and 191 to be displayed so that virtual reality is embodied through the first and second display arts 180 and 191. That is, the image that is digital processed by the processor 200 is delivered to the first and second display parts 180 and 191 to embody the virtual reality so that a main user can observe the virtual reality through the ocular lens 150. Additionally, the image that is digital processed by the processor 200 is also delivered to the pair of second display parts 191 of the assistant viewer 190 to embody virtual reality so that an assistant can observe the virtual reality through ocular lens 192, which is the same as that observed by the main user. Further, the image that is digital processed by the processor 200 is also delivered to the second display 182 of the first display part 180 to embody virtual reality so that a third party except the main user and the assistant can observe the virtual reality, which is the same as that observed by the main user through the ocular lens 150 and by the assistant through the ocular lens 192.

As described above, according to the stereo microscope of an embodiment of the present invention, the image capturing part captures the beam passing through the beam splitter part 162 of the prism 160 to capture an image and delivers the image to the processor 200, and the processor 200 digital processes the image captured by the pair of image capturing part 170 and delivers the image to the first and second display parts 180 and 191 to embody virtual reality. Therefore, a plurality of display can displays image of which quality is regular to embody virtual reality. That is, according to a conventional stereo microscope system, an irregular image is displayed by a display part due to a decrease and increase of light, but the stereo microscope according to the present invention, the image captured by the image capturing part 170 is digital processed by the processor 200, and the image that is digital processed by the processor 200 is delivered to each of the display part to embody virtual reality so that virtual reality with regular image regardless of change of amount of light.

The detailed description of the present invention is described with regard to the preferable embodiment of the present invention, however, a person skilled in the art may amend or modify the present invention within the spirit or scope in the following claim of the present invention.

What is claimed is:

1. A stereo microscope system comprising:
a pair of zoom units disposed between objective lens and a pair of ocular lenses;
a focusing lens disposed between the pair of zoom unit and the objective lens;
a pair of prisms disposed between the pair of zoom units and the pair of ocular lenses, the prisms having a reflecting part reflecting a main beam passing through the zoom units, and a beam splitter part reflecting a portion of the main beam reflected by the reflecting part toward the ocular lenses and transmitting other portion of the main beam, which is not reflected toward the ocular lenses;
a pair of image capturing part capturing beam passing through the beam splitter part to capture an image and delivering the image to a processor; and
a first display part connected to the processor to display an image that is captured by the pair of image capturing part and digital processed by the processor.

2. The stereo microscope system of claim 1, wherein the first display part comprises a pair of first displays disposed between the pair of ocular lenses and the pair of prisms to be connected to the processor, the first displays displaying the image that is digital processed by the processor.

3. The stereo microscope system of claim of claim 2, wherein the first displays are a liquid crystal display (LCD).

4. The stereo microscope system of claim of claim 1, wherein the first display part comprises a second display connected to the processor to display an image that is digital processed by the processor in order to observe the image not through the pair of ocular lenses.

5. The stereo microscope system of claim of claim 4, wherein the second display is a glassless 3D TV.

6. The stereo microscope system of claim of claim 1, further comprises an assistant viewer connected to the processor.

7. The stereo microscope system of claim of claim 6, wherein the assistant viewer comprises:
a pair of second displays connected to the processor to display an image that is digital processed by the processor; and
a pair of assistant ocular lenses through which an assistant observes the image displayed by the pair of second display parts.

8. The stereo microscope system of claim of claim 7, wherein the second display part is a liquid crystal display (LCD).
